(19) United States
(12) Patent Application Publication
(10) Pub. No.: US 2008/0160156 A1
(43) Pub. Date: Jul. 3, 2008

(54) Treatment of cooking oils and fats with precipitated silica materials

(76) Inventors: Michael C. Withiam, Landenberg, PA (US); Fitzgerald A. Sinclair, Bear, DE (US)

Correspondence Address: J.M. Huber Corporation Legal Department, 333 Thornall Street, Edison, NJ, 08837, US

(21) Appl. No.: 11/646,123

(22) Filed: Dec. 27, 2006

(51) Int. Cl. A23D 9/00

(52) U.S. Cl. 426/601

(57) ABSTRACT

The treatment of cooking oils and fats with specific types of precipitated silica materials to prolong the useful life of such oils and fats within restaurant settings. More particularly, such an invention encompasses the utilization of specific types of precipitated silica materials to filter such oils and/or fats. Such precipitated silica materials and treatments therewith aid to remove large amounts of free fatty acids after such oils and/or fats have been utilized to fry foodstuffs, as well as reduce the amount of additional oil and/or fat potentially necessary to bring the used oils and/or fats up to a level of permitted further utilization within a restaurant environment.

### FIELD OF THE INVENTION

This invention relates to the treatment of cooking oils and fats with specific types of precipitated silica materials to prolong the useful life of such oils and fats within restaurant and commercial food manufacturing settings. More particularly, such an invention encompasses the utilization of specific types of precipitated silica materials to filter such oils and/or fats. Such precipitated silica materials and treatments therewith aid to remove large amounts of free fatty acids after such oils and/or fats have been utilized to fry foodstuffs, as well as reduce the amount of additional oil and/or fat potentially necessary to bring the used oils and/or fats up to a level of permitted further utilization within a restaurant environment.

### BACKGROUND OF THE PRIOR ART

Cooking oils and fats are employed in general for the cooking or frying of foods such as chicken, fish, potatoes, potato chips, vegetables, and pies. Such frying may take place in a home or restaurant wherein food is prepared for immediate consumption or in an industrial frying operation where food is prepared in mass quantities for packaging, shipping, and future consumption.

In a typical restaurant frying operation, large quantities of edible cooking oils or fats are heated in vats to temperatures of from about 315 to about 400° F. or more, and the food is immersed in the oil or fat for cooking. During repeated use of the cooking oil or fat the high cooking temperatures, in combination with water from the food being fried, cause the formation of free fatty acids (or FFA). An increase in the FFA decreases the oil's smoke point and results in increasing smoke as the oil ages. Increased FFA content also causes excessive foaming of the hot fat and contributes to an undesirable flavor or development of dark color. Any or all of these qualities associated with the fat can decrease the quality of the fried food. There is additional evidence that the formation of free fatty acids and degradation products can be related to increased health risks.

Industrial frying operations involve the frying of large amounts of food for delayed consumption. Often, this is a continuous operation with the food being carried through the hot oil via a conveyor. Industrial fryers of meat and poultry must follow the strict FDA guidelines in terms of the length of time oils and fats may be used for deep fat frying purposes. Suitability of further or prolonged use can be determined from the degree of foaming during use or from color and odor of the oil and/or fat or from the flavor of the resultant fried food made therefrom. Fat or oil should be discarded when it foams over a vessel's side during cooking, or when its color becomes almost black as viewed through a colorless glass container. Filtering of used oil and/or fat is permitted, however, to permit further use, as well as adding fresh fat to a vessel and cleaning frying equipment regularly. Large amounts of sediment and free fatty acid content in excess of 2 percent are usual indications that frying fats are unwholesome and require reconditioning or replacement. Most industrial fryers use the 2% free fatty acid (FFA) limit, or less if mandated by their customers, for poultry as their main specification for oil quality, regardless of the food being fried.

In addition to hydrolysis, which forms free fatty acids, there occurs oxidative degeneration of fats which results from contact of air with hot oil, thereby producing oxidized fatty acids (or OFA). Heating transforms the oxidized fatty acids into secondary and tertiary by-products which may cause off-flavors and off-odors in the oil and fried food. Caramelization also occurs during the use of oil over a period of time, resulting in a very dark color of the oil which, combined with other by-products, produces dark and unappealing fried foods. Because of the cost resulting from the replacing of the cooking oils and fats after the use thereof, the food industries have searched for effective and economical ways to slow degradation of fats and oils in order to extend their usable life.

U.S. Pat. No. 5,597,600, issued to Munson et al., utilizes magnesium silicate of certain particle size to filter such used oils and/or fats as well. Such magnesium silicate materials provide effective filtering of such cooking oils and fats; however, there are limitations to free fatty acid removal levels as well as the need for relatively large amounts of extra oils and/or fats to be added to used sources in order to attain acceptable frying conditions.

Also in the prior art is a synthetic calcium silicate known in the trade under the name Silasorb® (Celite Corporation, Denver, Colo.). Such a product has been utilized as a proper filter media because it is very effective in lowering free fatty acid concentration. Silasorb lowers the free fatty acid (FFA) concentration of the oil by a combination of adsorption and neutralization. The use of such a material, however, often darkens the oil to a suspect level. In addition, the product of the neutralization of a fatty acid with an alkaline metal is a fatty acid soap. The amount of soap formed is dependent on the amount of alkaline metal present, and the initial percentage of free fatty acids in the oil. When the soap level is high, the oil foams. The use of Silasorb® in order to lower the free fatty acid concentration sometimes results in uncontrollable foaming.

Another prior material, a metal doped precipitated silica type, is Britesorb® from PQ Corporation Such a magnesium doped precipitated silica material has proven effective in filter such used oils and/or fats; however, generally, such Britesorb® materials exhibit a pore size between 50 and 200 Å, and BET surface area (as measured by nitrogen absorption) of 535 m²/g, and the particle size is above about 40 um. In essence, there is a large amount of surface area, with an appreciable amount taken up by pores that are of a critical size. This, in turn, delivers efficient utilization of the available pores within the silica materials, but the very high pore volume coupled with the need to dope the materials, adds to manufacturing cost.

There exists thus a definite need to improve each of these prior developments within the cooking oil/fat filtering area with less costly materials. A material and/or method that provides improved levels of free fatty acid reduction, improved color, and/or a significant reduction in the needed amount of added fresh oil or fat to be added to a used source would provide a much sought after advancement to the restaurant and/or industrial frying markets.

### SUMMARY OF THE INVENTION

It is therefore an advantage of the present invention to provide an improved procedure for removing free fatty acids and oil darkening color bodies from cooking oil or fat employed in restaurant frying operations or in industrial frying operations as compared with such previous developments. Another advantage is the ability to simultaneously utilize the benefits of certain materials within the prior art with supplementation of effects from the silica-based material additives of this invention.

Accordingly, this invention encompasses a method for treating cooking oil or fat comprising contacting cooking oil or fat with at least one precipitated silica material exhibiting a pore size of from 50-200 Å, preferably from 80-120, a BET surface area of from 200-500 m²/g, preferably from 250-450, and an average particle size of from 150-800 um, preferably from 200-400 um.

### DETAILED DESCRIPTION OF THE INVENTION

The present invention is particularly advantageous in that the useful life of cooking oil and/or fat (shortening), which has been used for the high temperature frying of foods, can be extended, thereby reducing the overall cost. The utilization of a specific, mesoporous precipitated silica material (as noted above) has not been undertaken previously for this type of filtering procedure. The closest art, that of the Britesorb® type, using the addition of metals in the structure to achieve very high pore volume has proven very effective at reducing free fatty acid levels and thus discoloration due to such unwanted components, from used frying oils and/or fats. It was further noted that such a specific precipitated silica filter material provided a level of filter efficacy, particularly for free fatty acid removal from target used oils and/or fats. The costs for such effective materials, however, are problematic in the commercial arena. There was thus determined a need to provide comparable if not better performance for much lower cost.

Of great importance, thus, to this invention was the provision of the produced pure silica materials to sufficiently large particle sizes (such as between 100 and 800 microns, preferably between 200 and 400 microns), coupled with a sufficiently large average pore size of 50 to 200 Angstroms (preferably from 80 to 120), in combination with a sufficiently small surface area of from 200 to 500 m²/g (preferably from 250 to 450). Such a material is mesoporous in structure such that the majority of pores that contribute to the surface area thereof are rather large in size. It has been theorized that this large amount of mesoporous structures within the filter material provides the beneficial improvements in fatty acid reduction as the pores themselves are sufficiently large to entrap the color bodies and target fatty acids therein. Specifically, a material that exhibits too great an amount of micropores will not exhibit the same degree of fatty acid removal effectiveness as many of the pores will not provide any capability of trapping such undesirable fatty acids during filtering. As such, the determination that such an undoped mesoporous precipitated silica permits greater efficiency, with a lower cost and complexity level for the manufacture thereof as compared to microporous types, is a highly surprising result. Additionally, the rather large average particle size contributes to the prevention of unwanted clogging and effective filtering and removal during use in a fryer vessel.

The resultant effects of free fatty acid removal, reduced discoloration, and overall “freshness” of the used cooking oil and/or fat were noted of these inventive materials and methods regardless of the pressures involved and flow rates followed. As such, these materials may be employed either as drop-in treatments or as materials within filter apparatuses for incorporation within frying systems and/or vessels. Other additives that may be included within these materials may include any type of material that contribute to improving oil and/or fat quality, including, without limitation, activated carbons (such as Activated Carbon Darco T-88 from American Norit Co., Jacksonville, Fla.), alumina (such as Basic pH Alumina A-2 from LaRoche Chemicals, Baton Rouge, La. and Neutral pH Alumina from M. Woelm Eschwege, Germany), bleaching materials (such as Bleaching Earth #1 Filtrol 105 from Harshow Filtrol, Cleveland, Ohio and Bleaching Earth #2 Tonsil Supreme LA from Saloman, Port Washington, N.Y.), silicates (such as Calcium Silicate Silasorb® from Manville Corp., Denver, Colo. and Magnesium Silicate MAGNESOL® XL from The Dallas Group, Whitehouse, N.J.), silicas (such as Silica #1 Britesorb® C200 from PQ Corp., Valley Forge, Pa. and Silica #2 Trisyl from W.R. Grace & Co., Baltimore, Md.), silica gel (such as Silica Gel 60 from Baxter Scientific Products, Obetz, Ohio), Silica gel 408 from W.R. Grace & Co., Baltimore, Md.) and Diatomaceous Earth (such as FW-18 from Eagle Picher, Reno, Nev.).

The method of the present invention is applicable to continuous filtration systems in which used cooking oil is circulated continuously through filtration units and back to the frying vats and/or vat systems wherein one or more times a day, the contents of each frying vat are filtered through a batch type filter. The specific precipitated silica materials alone, and/or the blends with other filter materials, may be utilized either as a precoat or a body feed in either a continuous or batch filtration system, or both, if desired.

In a conventional cooking apparatus, or in an industrial frying application, in general, at least 0.005 lb. of the filter medium, and preferably at least 0.01 lb. of the composition, is employed per pound of used cooking oil. In general, the amount of filter medium employed does not exceed 0.02 lb. per pound of used cooking oil.

### PREFERRED EMBODIMENTS OF THE INVENTION

Surface area was determined by the BET nitrogen adsorption methods of Brunaur et al., J. Am. Chem. Soc., 60, 309 (1938).

Pack or tapped density was determined by weighing 20.0 grams of product into a 250-mL plastic graduated cylinder with a flat bottom. The cylinder was closed with a rubber stopper and placed on a tap density machine and run for 15 minutes. The tap density machine is a conventional motor-gear reducer drive operating a cam at 60 rpm. The cam is cut or designed to raise and drop the cylinder a distance of 2.25 inch (5.715 cm) every second. The tapped density was calculated as the volume occupied by a known weight of product and expressed in g/ml.

Pour density is determined by weighing 100.0 grams product into a 250-mL graduated cylinder and recording the volume occupied.

Median particle size (MPS) was determined using a Model LA-910 laser light scattering instrument available from Horiba Instruments, Boothwyn, Pa. A laser beam was projected through a transparent cell which contains a stream of moving particles suspended in a liquid. Light rays which strike the particles are scattered through angles which are inversely proportional to their sizes. The photodetector array measures the quantity of light at several predetermined angles. Electrical signals proportional to the measured light flux values are then processed by a microcomputer system to form a multi-channel histogram of the particle size distribution.

Oil absorption, using either linseed oil, was determined by the rubout method. This method is based on a principle of mixing oil with a silica by rubbing with a spatula on a smooth surface until a stiff putty-like paste is formed. By measuring the quantity of oil required to have a paste mixture, which will curl when spread out, one can calculate the oil absorption value of the silica—the value which represents the volume of oil required per unit weight of silica to saturate the silica sorptive capacity. Calculation of the oil absorption value was done as follows:

$$\begin{matrix}Oil absorption = \frac{ml oil absorbed}{weight of silica , grams} \times 100 \\ = ml oil / 100 gram silica\end{matrix}$$

The 5% pH was determined by weighing 5.0 grams silica into a 250-ml beaker, adding 95 ml deionized or distilled water, mixing for 7 minutes on a magnetic stir plate, and measuring the pH with a pH meter which has been standardized with two buffer solutions bracketing the expected pH range.

The chemical composition was determined according to the methods described in Food Chemicals Codex (FCC V) under the monographs for sodium magnesium aluminosilicate and calcium silicate.

To determine free fatty acid reductions, initial and treated oils were analyzed by the official American Oil Chemists' Society methods for percent free fatty acids (Ca 5a-40).

### Absorbent Production

### COMPARATIVE EXAMPLE 1

Comparative Example 1 was Britesorb® magnesium doped—silica gel filter material as noted previously. Several properties of this example were determined according to the methods described above and are summarized in Table 1 below.

### COMPARATIVE EXAMPLE 2

Comparative Example 2 is commercially produced magnesium silicate, Magnesol® XL from the Dallas Group Several properties of this example were determined according to the methods described above and are summarized in Table 1 below. Many compounds have been used for the beneficiation of vegetable oils and animal fats used in the preparation of fried foods. While many are simply passive filtration aids, some are known to provide benefits in the removal certain thermal degradation products considered to be harmful or toxic. In some cases the several compounds have to be mixed or added separately to achieve to greatest benefit.

### COMPARATIVE EXAMPLE 3

Particles of commercially available Silica Gel 408 Type RD desiccant grade silica gel available from W.R. Grace & Company, Columbia, Md., were sized by sieving as previously described above to recover particles sized between 850 μm and 425 μm (in essence a second control example).

### INVENTIVE EXAMPLE 1

1600 mls of 1.5% of sodium sulfate solution were introduced into a mixing vessel, followed thereafter by 1000 mls of 24.7% sodium silicate 3.3MR. The mixture was then heated to 84° C. Once that temperature was reached, 11.4% sulfuric acid was then added at a rate of 29 ml/min until a pH of 7.8 was attained. At that point, the temperature was then raised to 93° C. while acid addition continued until a pH of 7.5 was reached (with the rate of heating and pH adjustment controlled to attain the 7.5 pH target and 92° C. temperature simultaneously; about 3 minutes). Subsequently, a co-addition of 3.3MR 15% sodium silicate and 11.4% sulfuric acid was started at a rate of 5.5 ml/min and 6.7 ml/min respectively for exactly 30 minutes while maintaining the pH between 7.4 and 7.6. Silicate addition was stopped after 30 minutes while acid addition continued until the pH was 6.5. After permitting reaction for ten minutes at 93° C., the pH was then readjusted to 6.5. The resultant material was then filtered and washed with two displacements of water and then allowed to oven dry at 105° C. for about 8 hours.

### INVENTIVE EXAMPLE 2

A drop tank was prepared including 1.4 liters 50% NaOH in 1200 liters of water. And heated to 90° C. using steam. In a separate reactor, 225 liters of room temperature 11.4% sulfuric acid was then added. The mixture was then agitated enough to stir, but not enough to splash, after which 3.3MR 24.7% sodium silicate was then added at a rate of 4.5 liters/min until a pH of 2.5 was achieved. At that point, the silicate addition rate was reduced to 2 liters/min until a pH of 2.8 was reached. Once the pH of 2.85 was reached, the silicate flow was stopped and the resultant composition was allowed to mix for 5 mins until the pH stabilized at 3.0. The separate reactor batch was then added into the drop tank and the temperature was maintained at 90° C. with no agitation for 45 minutes. At the 22 and 44 minute points, however, the contents were agitated for 1 minute at 500 rpm. The resultant gel slurry was then washed and filtered with a filter press (EIMCO) under low pressure until the filtrate conductivity was measured to be below 3000 mho. The resultant material was then air purged for 10 minutes and the final gel cake was oven dried (or it could be diluted) to about 7 to 8% solids, then spray dried.

### INVENTIVE EXAMPLE 3

To 960 mls of water was added 14.5 g of sodium sulfate within a mixing vessel (and stirred until completely dissolved), followed thereafter by 1265 mls of 15% sodium silicate 3.3MR. The mixture was then heated to 72° C. Once that temperature was reached, 11.4% sulfuric acid was then added at a rate of 41 ml/min until a pH of 9.5 was attained. At that point, the temperature was then raised to 92° C. while acid addition continued until a pH of 7.5 was reached (with the rate of heating and pH adjustment controlled to attain the 7.5 pH target and 92° C. temperature simultaneously; about 3 minutes). Subsequently, a co-addition of 3.3MR 15% sodium silicate and 11.4% sulfuric acid was started at a rate of 4.02 ml/min and 4.0 ml/min respectively for exactly 30 minutes while maintaining the pH between 7.4 and 7.6. Silicate addition was stopped after 30 minutes while acid addition continued until the pH was 5.5. After permitting reaction for ten minutes at 93° C., the pH was then readjusted to 5.5. The resultant material was then filtered and washed with two displacements of water and then allowed to oven dry at 105° C. for about 8 hours.

The inventive and comparative materials above exhibited the following characteristics:

TABLE 1

| | BET | Total | Median | | | |
|---|---|---|---|---|---|---|
| | Surface | Pore | Pore | Particle | | |
| | Area, | Volume, | diameter, | Size, | | |
| | m²/g | (cm³/g) | (Å) | um | (5%) pH | % T@ 589 nm |
| Comparative Example 1 | 535 | 1.2 | 120 | 40 | 8.7 | 74.8 |
| Comparative Example 2 | 400 | 0.88 | 95 | 20–75 | 8.5 | 69.4 |
| Comparative Example 3 | 750 | 0.35 | <25 | 60 | 6.5 | 51.4 |
| Inventive Example 2 | 259 | 1.05 | 190 | 40 | 8.5 | 70.2 |
| Inventive Example 3 | 289 | | | | 6.82 | 76.4 |
| Control (Unfiltered Oil) | — | — | — | — | — | 44.4 |
| 97% glycerine | — | — | — | — | — | 100.0 |

TABLE 2

| | BET | | | | | |
|---|---|---|---|---|---|---|
| | Surface | Total | Med Pore | | | |
| | Area, | Pore Vol | diameter | Particle | | |
| | m²/g | (cm³/g) | (Å) | Size um | 5% pH | % T @ 589 nm |
| Comparative Example 1 | 535 | 1.2 | 120 | 40 | 8.7 | 77.2 |
| Comparative Example 2 | 400 | 0.88 | 95 | 20–75 | 8.5 | 75.2 |
| Inventive Example 3 | 289 | 1.03 | 134 | 40 | 6.82 | 80.0 |
| Inventive Example 2 | 259 | 1.05 | 190 | 40 | 8.5 | 74.2 |
| Control (Unfiltered Oil) | — | — | — | — | — | 60.8 |
| 97% glycerine | — | — | — | — | — | 100.0 |

TABLE 3

| | Inventive | Inventive | Inventive | Comparative | Comparative | Comparative |
|---|---|---|---|---|---|---|
| | Example 1 | Example 2 | Example 3 | Example 1 | Example 2 | Example 3 |
| % SiO₂ | >91 | >91 | 93.5 | 95 | 67 | 98 |
| % MgO | 0 | 0 | 0 | 4 | 15 | 0 |

### Oil Filtration

Oil samples were obtained after use from a local fryer just prior to oil disposal, reheated to 360° F., and thereafter allowed to cool to room temperature. Subsequently, a sample was provided by weighing 94.0 g of the used oil and heated to 140° C. 6 g of the filter absorbent (from the above examples) was then added and the mixture was stirred with a magnetic stirrer. The heat was maintained and the mixture was stirred for exactly 10 minutes, after which the resultant and collected absorbent was then filtered through a 70 cm #4 Whatman filter paper support on an appropriated Buchner funnel. The clarified oil was then cooled and tested.

Test 1 below involved recovering a sample of abused vegetable oil after several days of frying a variety of food products, including meats, fish and vegetables. Oil samples were obtained just prior to oil disposal. The oil was reheated in a stainless beaker on a commercial hotplate to 360° F. From the beaker is extracted 94 g, placed into a 250 cc beaker with 6 g absorbent and digested for 15 minutes. It is then filtered as described, above.

Similarly, Test 2 below involved recovering a sample of abused vegetable oil after several days of frying a variety of food products, primarily consisting of poultry. Oil samples were obtained just prior to oil disposal. The oil was reheated, treated and evaluated, as described above.

### Performance Evaluation

Several absorbents were tested using the methods described above before being recovered and analyzed. The composition of the various tests is shown in Table 2 below.

TABLE 4

| | | | Wt | Wt Ab- |
|---|---|---|---|---|
| | | | Oil, | sorbent, |
| Test | Absorbent | Oil Source | g | g |
| 1 | 0% | Abused Commercial Oil 1 | 100 | 0 |
| 1 | 6% Inventive | Abused Commercial Oil 1 | 94 | 6 |
| | Example 1 | | | |
| 1 | 6% Inventive | Abused Commercial Oil 1 | 94 | 6 |
| | Example 2 | | | |
| 1 | 6% Comparative | Abused Commercial Oil 1 | 94 | 6 |
| | Example 1 | | | |
| 1 | 6% Comparative | Abused Commercial Oil 1 | 94 | 6 |
| | Example 2 | | | |
| 1 | 6% Comparative | Abused Commercial Oil 1 | 94 | 6 |
| | Example 2 | | | |

TABLE 5

| | | | | |
|---|---|---|---|---|
| 2 | 0% | Abused Commercial Oil 2 | 100 | 0 |
| 2 | 6% Inventive | Abused Commercial Oil 2 | 94 | 6 |
| | Example 2 | | | |
| 2 | 6% Inventive | Abused Commercial Oil 2 | 94 | 6 |
| | Example 3 | | | |
| 2 | 6% Comparative | Abused Commercial Oil 2 | 94 | 6 |
| | Example 1 | | | |
| 2 | 6% Comparative | Abused Commercial Oil 2 | 94 | 6 |
| | Example 2 | | | |
| 2 | 6% Comparative | Abused Commercial Oil 2 | 94 | 6 |
| | Example 3 | | | |

### Oil samples were tested using standard methods for clarity and Free fatty Acid content using the methods described above.

The absorbent of this invention was analyzed and found to provide the following benefits.

| | | Oil | Free |
|---|---|---|---|
| | Absorbent | Color/Clarity | Fatty |
| Test | Amount, % | % T | Acids |
| 1 | 0% | 44.4 | — |
| 1 | 6% Inv. Ex. 2 | 70.2 | — |
| 1 | 6% Inv. Ex. 3 | 76.4 | — |
| 1 | 6% Comp. Ex. 1 | 74.8 | — |
| 1 | 6% Comp. Ex. 2 | 69.4 | — |
| 1 | 6% Comp. Ex. 3 | 51.4 | — |
| 2 | 0% | 60 | 0.88 |
| 2 | 6% Inv. Ex. 1 | 71 | 0.69 |
| 2 | 6% Inv. Ex. 2 | 74.2 | 0.62 |
| 2 | 6% Inv. Ex. 3 | 80.0 | 0.63 |
| 2 | 6% Comp. Ex. 1 | 77.2 | 0.75 |
| 2 | 6% Comp. Ex. 2 | 75.2 | 0.68 |

The absorbent of this invention shows a significant reduction in FFA values as the addition level is increased from 0 to 6% and was observed to increase less than the commercial magnesium silicate. The observed color/clarity of the treated oils was measured empirically and was found to be better than that of the commercial magnesium silicate as well at a laboratory scale.

Furthermore, when introduced within an actual restaurant setting, the amount of needed fat or oil to supplement the used source after filtering with the inventive material was less than that needed for the same amount of magnesium silicate filter medium. This provides additional cost savings to the end user. Likewise, on such a larger scale, the color of the used oil filtered by the inventive medium was found to empirically be better than that of the comparative magnesium silicate products.

While the invention will be described and disclosed in connection with certain preferred embodiments and practices, it is in no way intended to limit the invention to those specific embodiments, rather it is intended to cover equivalent structures structural equivalents and all alternative embodiments and modifications as may be defined by the scope of the appended claims and equivalence thereto.

What is claimed is:

1. A method for treating cooking oil or fat comprising contacting cooking oil or fat with at least one precipitated silica material exhibiting an average pore size of from 50-200 Å, a BET surface area of from 200-500 m²/g, and an average particle size of from 150-800 nm.

2. The method of claim 1 wherein said material exhibits a pore size from 80-120 Å, a BET surface area of from 250 to 450 m²/g, and an average particle size of from 200 to 400 nm.
